(19) United States
(12) Patent Application Publication
(10) Pub. No.: US 2003/0107824 A1
(43) Pub. Date: Jun. 12, 2003

(54) Cemented objective lens and manufacturing method thereof

(75) Inventor: Shuichi Takeuchi, Saitama-ken (JP)

Correspondence Address: GREENBLUM & BERNSTEIN, P.L.C., 1941 Roland Clarke Place, Reston, VA, 20191, US

(73) Assignee: PENTAX Corporation, Tokyo (JP)

(21) Appl. No.: 10/308,030

(22) Filed: Dec. 3, 2002

(30) Foreign Application Priority Data
Dec. 4, 2001 (JP) 2001-370356

(51) Int. Cl. G02B 9/00

(52) U.S. Cl. 359/796

(57) ABSTRACT

A cemented objective lens includes a first lens made of photo-curing resin or thermo-curing resin, and a second lens made of resin to which the first lens is cemented. The cemented objective lens may be manufactured in accordance with the method including the following four steps, a step for forming the second lens made of resin, a step for setting the second lens in a molding device to form a cavity corresponding to the shape of the first lens, a step for charging photo-curing resin or thermo-curing resin into the cavity and a step for curing the photo-curing resin or thermo-curing resin by applying light or heat.

### BACKGROUND OF THE INVENTION

The present invention relates to an objective lens formed by cementing a plurality of lenses made of different materials, an optical system for an optical pick-up including the cemented objective lens, and a method for manufacturing such a cemented objective lens.

An optical system for an optical pick-up using an optical disc such as a DVD (Digital Versatile Disc), a CD (Compact Disc) and a CD-R (CD Recordable) is provided with a laser source for emitting a laser beam, an objective lens for converging the laser beam onto an information layer of an optical disc and a sensor for receiving the laser beam reflected by the optical disc to detect signals. In order to reduce chromatic aberration, a cemented objective lens that consists of a plurality of lenses having different dispersion has been employed. A conventional cemented objective lens is formed by cementing glass lenses, in general. For increasing NA (numerical aperture), the cemented surfaces of the lenses should be formed as aspherical surfaces to compensate for spherical aberration.

However, it is difficult to match a shape of a convex cemented surface of one lens with a shape of a concave cemented surface of the other lens to cement the lenses without a gap. Particularly, a precise aspherical shape can be hardly formed on a glass lens through a grinding process. Further, extremely high accuracy will be required for aligning the lenses that are independently ground. Accordingly, such a cemented lens is hardly manufactured practically.

A hybrid lens having a glass lens and a resin layer formed on the glass lens is known as prior art. The resin layer may be made of photo-curing resin or made of thermo-cured resin to form an aspherical surface or a diffraction surface on the spherical surface of the glass lens.

However, such a technique for forming a resin layer on a glass lens cannot be applied to form a cemented lens consisting of a glass lens and a resin lens. In a cemented lens in which the volume of resin is relatively large, due to a difference of thermal expansion coefficients between glass and resin, a distortion and/or an exfoliation may occur as shrinking amounts during cooling process are different.

### SUMMARY OF THE INVENTION

The present invention is advantageous in that there is provided a cemented objective lens, which is capable of using a desirable spherical surface as a cemented surface and can be formed easily.

According to a first aspect of the invention, there is provided a cemented objective lens consisting of a plurality of lenses, each of which is made of resin, at least one said plurality of lenses being made of photo-curing resin. Alternatively, the at least one of the plurality of lenses is made of thermo-curing resin.

According to a further aspect of the invention, there is provide a cemented objective lens including a first lens made of photo-curing resin, and a second lens made of resin to which the first lens is cemented.

According to another aspect of the invention, there is provided a cemented objective lens including a first lens made of thermo-curing resin, and a second lens made of resin to which the first lens is cemented.

The cemented objective lens may be manufactured in accordance with a method, which includes:

(a) forming the second lens made of resin;

(b) setting the second lens in a molding device to form a cavity corresponding to the shape of the first lens;

(c) charging photo-curing resin or thermo-curing resin into the cavity; and

(d) curing the photo-curing resin or thermo-curing resin by applying light or heat.

Since the cemented surface of the first lens is automatically formed by charging and curing the resin, there is no need to form the cemented surface of the first lens and to align with the second lens. Accordingly, there is no restraint on the cemented surface, which allows forming a complex aspherical surface. For example, the cemented surface may be an aspherical surface to correct spherical aberration.

Further, since the first and second lenses are made of resin, thermal expansion coefficients are nearly equal to each other, which prevents a distortion and an exfoliation with temperature variation.

In order to compensate for residual chromatic aberration, a diffractive lens structure may be formed on at least one outside surface of the cemented objective lens. Since the chromatic aberration is corrected by employing the combination of a pair of lenses having different dispersions, the diffractive lens structure may correct residual chromatic aberration, which decreases the number of ring areas of the diffractive lens structure.

Optionally, the first lens has a positive power and the second lens has a negative power. In a particular case, the first lens is made of the photo-curing resin or the thermo-curing resin.

Optionally, the cemented surfaces of the first lens and the second lenses are aspherlcal surfaces.

Further optionally, a diffractive lens structure may be formed on at least one surface, which is not the cemented surfaces, of the first and second lenses.

In an embodiment, the diffractive lens structure is formed on the first lens.

Optionally, an NA of the cemented objective lens is greater than 0.6.

### DESCRIPTION OF THE ACCOMPANYING DRAWINGS

FIG. 1 shows an optical system for an optical pick-up including a cemented objective lens according to an embodiment of the invention;

FIG. 2 is a sectional view of a molding device showing a manufacturing method of the cemented objective lens shown in FIG. 1;

FIG. 3 is a lens diagram showing the cemented objective lens according to a first concrete example, and an optical disc;

FIG. 4A is a graph showing spherical aberration of the cemented objective lens shown in FIG. 1;

FIG. 4B is a graph showing chromatic aberration, represented by the spherical aberrations at two different wavelengths, of the cemented objective lens according to the first concrete example;

FIG. 5A is a graph showing spherical aberration of the cemented objective lens according to a second concrete example;

FIG. 5B is a graph showing chromatic aberration, represented by the spherical aberrations at two different wavelengths, of the cemented objective lens according to the second concrete example;

FIG. 6 is a lens diagram showing the cemented objective lens according to a third concrete example, and the optical disc;

FIG. 7A is a graph showing spherical aberration of the cemented objective lens according to the third concrete example;

FIG. 7B is a graph showing chromatic aberration, represented by the spherical aberrations at two different wavelengths, of the cemented objective lens according to the third concrete example;

FIG. 8 is a lens diagram showing the cemented objective lens according to a fourth concrete example, and the optical disc;

FIG. 9A is a graph showing spherical aberration of the cemented objective lens according to the fourth concrete example; and

FIG. 9B is a graph showing chromatic aberration, represented by the spherical aberrations at two different wavelengths, of the cemented objective lens according to the fourth concrete example;

### DESCRIPTION OF THE EMBODIMENT

An embodiment according to the present invention will be described hereinafter with reference to the accompanying drawings.

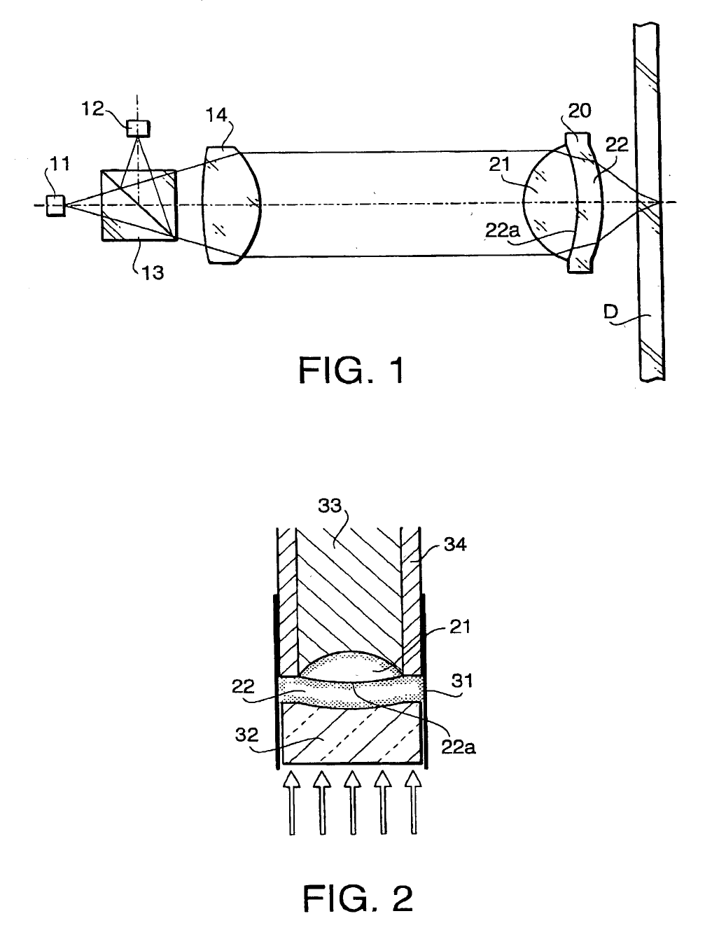

FIG. 1 shows an optical system of an optical pick-up embodying the present invention.

The optical system includes a laser diode 12, a beam splitter 13, a collimating lens 14, a cemented objective lens 20 and a sensor 11. A divergent laser beam emitted from the semiconductor laser 12 is reflected by the beam splitter 13 and collimated by the collimating lens 14. The collimated laser beam is converged by the cemented objective lens 20 onto an information layer of an optical disc D through a cover layer thereof. The laser beam reflected by the optical disc D passes through the cemented objective lens 20, the collimating lens 14 and the beam splitter 13 to be received by the sensor 11. The sensor 11 outputs a focusing error signal, a tracking error signal and a reproducing signal of the recorded information during a reproducing cycle.

The cemented objective lens 20 is a rotationally symmetrical lens that has a first lens 21 and a second lens 22 arranged In this order from the laser diode side. The first lens 21 is a biconvex lens having a positive power and the second lens 22 is a meniscus lens having a negative power. The convex surface on the optical disc side of the first lens 21 matches the corresponding concave surface of the second lens 22. That is, the surfaces are cemented with each other without a gap.

The first lens 21 is made of photo-curing resin. The second lens 22 is made of resin such as thermoplastic resin. The optical dispersion of the resin of the first lens 21 is different from that of the second lens 22 so as to compensate for chromatic aberration of the cemented objective lens 20 as a whole.

A manufacturing method of the cemented objective lens 20 will be described with reference to FIG. 2. The manufacturing method includes the following steps.

(a) Step for forming the second lens 22 made of resin.

(b) Step for setting the second lens 22 in a molding device to form a cavity corresponding to the shape of the first lens 21.

(c) Step for charging photo-curing resin into the cavity.

(d) Step for curing the photo-curing resin by applying light.

In step (a), the second lens 22 is formed by injection molding or grinding.

In step (b), the second lens 22 is set in the molding device as shown in FIG. 2.

FIG. 2 is a sectional view of the molding device that consists of a cylindrical outer frame 31, a glass stopper 32, a molding die 33 and a spacer 34. The second lens 22 is inserted in the cylindrical outer frame 31, fitting inside the outer frame 31 coaxially. The glass stopper having the same diameter as the second lens 22 is also inserted in the cylindrical outer frame 31 to support the second lens 22 at the side of the optical disc (the lower side in FIG. 2). While there is no need to match the shape of the surface of the glass stopper 32 that contacts the second lens 22 with the shape of the second lens 22 because the glass stopper 32 is not used as a molding die, it is preferable that the glass stopper 32 fits the second lens 22 to insure accuracy. The molding die 33 is inserted in the cylindrical outer frame 31 from the opposite side of the glass stopper 32. The tip edge of the molding die 33 contacts the cemented surface 22a of the second lens 22 to form a cavity corresponding to the shape of the first lens 21. The spacer 34 fills a gap between the cylindrical outer frame 31 and the molding die 33 to locate the die coaxially.

In step (c), photo-curing resin is charged into the cavity formed between the cemented surface 22a of the second lens 22 and the molding die 33.

In step (d), ultraviolet light is projected from the lower side as indicated by arrows in FIG. 2. The projected light transmits through the glass stopper 32 and the second lens 22, irradiating the photo-curing resin charged in the cavity. The photo-curing resin reacts to the irradiated ultraviolet light and cures in the form of the cavity.

In accordance with the above-described method, the first lens 21 is formed on the cemented surface 22a of the second lens 22, thereby forming the cemented objective lens 20.

It should be noted that the above method is an exemplary method, and can be modified. For example, in steps (b) and (c), the molding die 33 may be inserted after the resin material is charged onto the surface 22a of the second lens 22.

Since the cemented surface of the first lens 21 is automatically formed by charging and curing the resin, there is no need to form the cemented surface of the first lens 21 separately, and to coaxially align the first lens 21 with the second lens 22. Accordingly, there is no restraint in forming the aspherical surface, which allows design of a relatively complex aspherical surface. The cemented surfaces are aspherical surfaces to compensate for spherical aberration.

Further, according to the embodiment, the first lens 21 is cemented to the second lens 22 without adhesive, which circumvents the problem such as uneven thickness of adhesive.

Still further, since the first and second lenses 21 and 22 are made of resin, thermal expansion coefficients are nearly equal to each other, which prevents a distortion and an exfoliation with temperature variation due to difference of degrees of shrinkage between two lenses.

Furthermore, since the first lens 21 is not formed by injection molding, there is no need to keep an edge thickness for setting a gate through which resin is injected. Therefore, the edge thickness can be reduced to a limit even if the first lens 21 is a positive lens, which decreases the thickness of the first lens 21, thereby increasing a back focus.

The first lens 21 may be made of thermo-curing resin. In such a case, a stopper made of heat-resistant material such as metal and ceramics is employed instead of the glass stopper 32 and heat is applied to the thermo-curing resin instead of projecting the ultraviolet light.

Four concrete examples of the cemented objective lens 20 according to the above-described construction will be described hereinafter.

### First Concrete Example

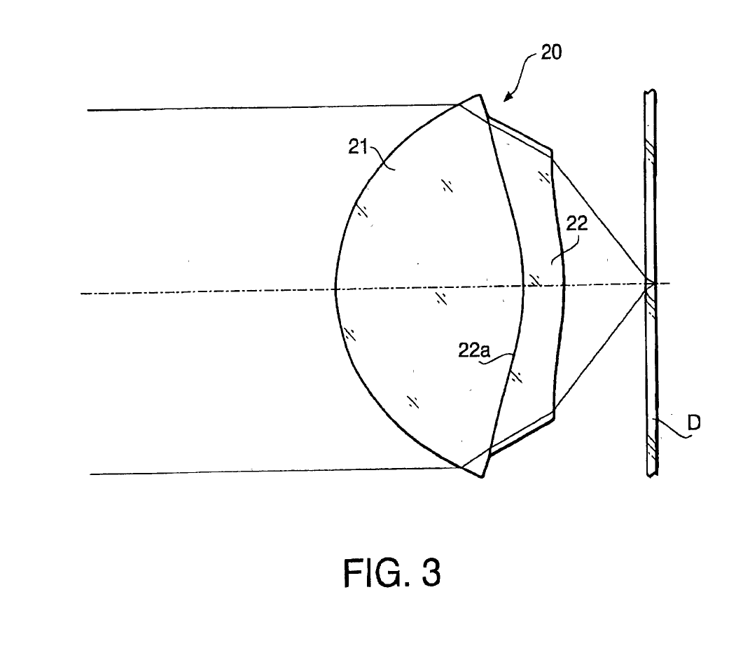

FIG. 3 is a lens diagram showing the cemented objective lens 20 of the first concrete example and the optical disc D. The first lens 21 of the objective lens 20 is made of ultraviolet-curing resin (photo-curing resin), and the second lens 22 is made of thermoplastic resin.

The numerical configuration of the first concrete example is indicated in TABLE 1. The surface number 1 represents the laser source side surface of the first lens 21, the surface number 2 represents the cemented surface 22a, the surface number 3 represents the optical disc side surface of the second lens 22, and the surface numbers 4 and 5 represent the cover layer of the optical disc D.

In TABLE 1, λ denotes a working wavelength (unit:nm), f denotes a focal length (unit:mm) of the objective lens 20, NA denotes a numerical aperture, r denotes a radius of curvature (unit:mm) of a paraxial shape of the surface, d denotes a distance (unit:mm) between the surfaces along the optical axis, n (405 nm) denotes refractive index at 405 nm and n (406 nm) denotes refractive index at 406 nm.

TABLE 1
λ = 405 nm f = 2.50 mm NA 0.80

| Surface | | | | |
|---|---|---|---|---|
| Number | r | d | n (405 nm) | n (406 nm) |
| 1 | 1.585 | 2.30 | 1.50962 | 1.50947 |
| 2 | −2.230 | 0.50 | 1.62231 | 1.62190 |
| 3 | −2.500 | 0.99 | — | — |
| 4 | ∞ | 0.10 | 1.62231 | 1.62190 |
| 5 | ∞ | — | — | — |

The surfaces whose surface numbers are 1, 2 and 3 of the first and second lenses 21 and 22 are rotationally-symmetrical aspherical surfaces. A rotationally-symmetrical aspherical surface is expressed by the following equation:

$$X ( h ) = \frac{{h}^{2} c}{1 + \sqrt{1 - ( 1 + κ ) {h}^{2} {c}^{2}}} + {A}_{4} {h}^{4} + {A}_{6} {h}^{6} + {A}_{8} {h}^{8} + {A}_{10} {h}^{10} + {A}_{12} {h}^{12} . . .$$

where X (h) is a sag, that is, a distance of a curve from a tangential plane at a point on the surface where the height from the optical axis is h, c is a curvature (1/r) of the vertex of the surface, κ is a conic constant, A₄, A₆, A₈, A₁₀ and A₁₂ are aspherical surface coefficients of fourth, sixth, eighth, tenth and twelfth orders, respectively.

The conic constants and the aspherical coefficients that define the aspherical surfaces are shown in TABLE 2.

TABLE 2

| Surface Number | 1 | 2 | 3 |
|---|---|---|---|
| κ | −0.6500 | 0.0000 | 0.0000 |
| A₄ | −2.2100 × 10⁻³ | 4.4000 × 10⁻² | 1.1200 × 10⁻¹ |
| A₆ | −4.2700 × 10⁻⁴ | 2.2500 × 10⁻³ | −2.8600 × 10⁻² |
| A₈ | 2.8500 × 10⁻⁵ | −2.7000 × 10⁻⁴ | 5.2810 × 10⁻³ |
| A₁₀ | 8.1300 × 10⁻⁵ | 0.0000 | −1.2770 × 10⁻⁴ |
| A₁₂ | −7.4150 × 10⁻⁶ | 0.0000 | −1.5987 × 10⁻⁴ |

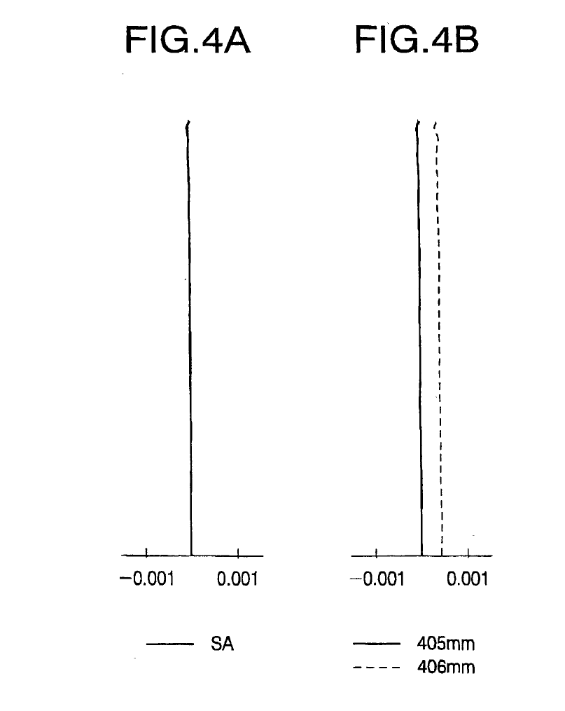

FIG. 4A is a graph showing spherical aberration of the cemented objective lens 20 according to the first concrete example at the working wavelength (405 nm) and FIG. 4B is a graph showing chromatic aberrations thereof represented by spherical aberrations at 405 nm and 406 nm. The vertical axis of each graph represents numerical aperture (NA) and the horizontal axis represents the amount of the spherical aberration (unit : mm).

FIG. 4A shows that the aspherical surfaces correct the spherical aberration well. FIG. 4B shows that the difference in optical dispersion corrects the chromatic aberration.

### Second Concrete Example

The objective lens of the second concrete example has a diffractive lens structure formed on the first surface (the laser source side surface of the first lens 21) of the cemented objective lens 20 of the first concrete example. That is, the basic construction of the second concrete example is the same as the first concrete example. The numerical values are indicated in TABLE 3 and TABLE 4. It should be noted that the diffractive lens structure is added in the second concrete example. Additionally, the shape of the first surface (surface number is 1) defined in TABLE 3 and TABLE 4 represents a base curve, which is the shape of the surface of the refractive lens when the diffractive lens structure is not formed, of the first surface.

TABLE 3
λ = 405 nm f = 2.50 mm NA 0.80

| Surface | | | | |
|---|---|---|---|---|
| Number | r | d | n (405 nm) | n (406 nm) |
| 1 | 1.728 | 2.30 | 1.50962 | 1.50947 |
| 2 | −2.230 | 0.50 | 1.62231 | 1.62190 |
| 3 | −2.500 | 0.99 | — | — |
| 4 | ∞ | 0.10 | 1.62231 | 1.62190 |
| 5 | ∞ | — | — | — |

TABLE 4

| Surface Number | 1 | 2 | 3 |
|---|---|---|---|
| κ | −0.5000 | 0.0000 | 0.0000 |
| A₄ | −2.2525 × 10⁻³ | 4.4000 × 10⁻² | 1.1200 × 10⁻¹ |
| A₆ | −1.2060 × 10⁻³ | 2.2500 × 10⁻³ | −2.8600 × 10⁻² |
| A₈ | −5.8420 × 10⁻⁴ | −2.7000 × 10⁻⁴ | 5.2810 × 10⁻³ |
| A₁₀ | 2.5956 × 10⁻⁴ | 0.0000 | −1.2770 × 10⁻⁴ |
| A₁₂ | −2.4805 × 10⁻⁵ | 0.0000 | −1.5987 × 10⁻⁴ |

The diffractive lens structure is defined by an additional optical path length added thereby. The additional optical path length is expressed by the following optical path difference function Φ(h):

Φ(h)=(P₂h²+P₄h⁴+P₆h⁶+. . . )×m×λ

where P₂, P₄ and P₆ are coefficients of second, fourth and sixth orders, h is a height from the optical axis, m is a diffraction order and λ is a wavelength of an incident light beam. The optical path difference function Φ(h) shows optical path difference between an imaginary ray that was not diffracted by the diffractive lens structure and a diffracted actual ray that are incident on the diffractive lens structure at the same point whose distance from the optical axis is h. The coefficients that define the diffractive lens structure formed on the first surface are shown in TABLE 5.

TABLE 5

| Surface Number | 1 |
|---|---|
| P₂ | −3.2800 × 10 |
| P₄ | −2.3500 |
| P₆ | 1.7580 |
| P₈ | −9.4500 × 10⁻¹ |
| P₁₀ | −3.0600 × 10⁻² |

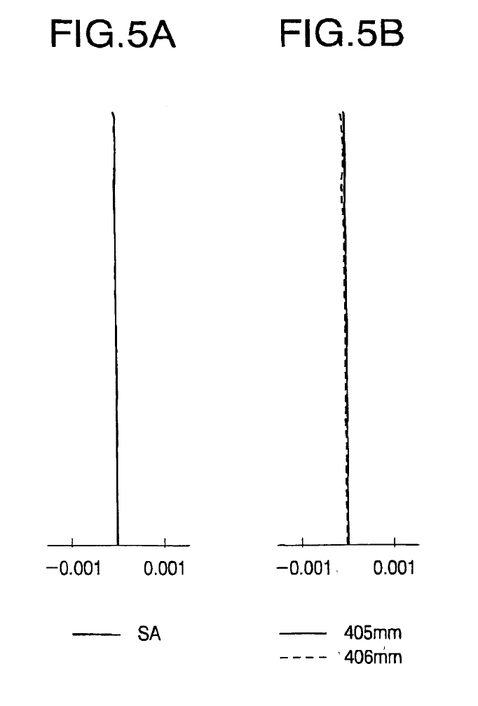

FIG. 5A is a graph showing spherical aberration of the cemented objective lens 20 according to the second concrete example at the working wavelength (405 nm) and FIG. 5B is a graph showing chromatic aberrations thereof represented-by spherical aberrations at 405 nm and 406 nm.

FIG. 5A shows that the aspherical surfaces correct the spherical aberration well. FIG. 5B shows that the diffractive lens structure further corrects the chromatic aberration as compared with the first concrete example.

In the second concrete example, since the chromatic aberration is corrected by employing the combination of a pair of lenses having different dispersions, the diffractive lens structure may correct residual chromatic aberration, which decreases the number of ring areas of the diffractive lens structure.

If the first lens is formed through the injection molding, high viscosity of resin obstructs an accurate transformation of the pattern of the diffractive lens structure formed to the molding die. Further, the transformed diffractive lens structure may stick on the molding die due to shrinkage during cooling, which causes deforming and/or crack of the diffractive lens structure.

On the other hand, since the photo-curing resin and thermo-curing resin are easy-flow materials at room temperature, they can get in the minute pattern of the diffractive lens structure formed on the molding die. Accordingly, the pattern can be easily and accurately transformed to the first lens 21.

Particularly, since the photo-curing resin is used to form the first lens 21, the first lens 21 cures at room temperature, which prevents problems during heat treatment.

### Third Concrete Example

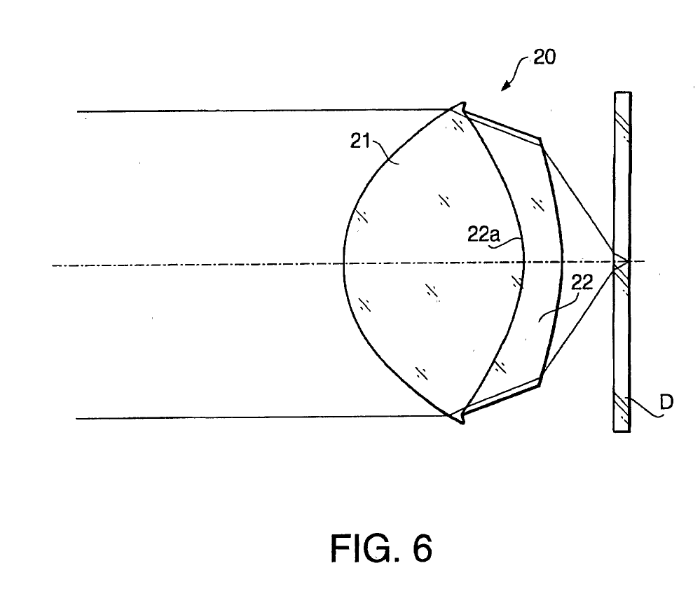

FIG. 6 is a lens diagram showing the cemented objective lens 20 of the third concrete example and the optical disc D. The first and second lenses 21 and 22 of the objective lens 20 are made of ultraviolet-curing resin (photo-curing resin). In the third concrete example, the second lens 22 is independently formed in a glass molding die, and then the first lens 21 is formed on the cemented surface 22a of the second lens 22 through the method shown in FIG. 2. In the same manner as the second concrete example, the diffractive lens structure is formed on the first surface (laser source side surface) of the first lens 21.

The basic numerical configuration of the third concrete example is described in TABLE 6 and TABLE 7. The coefficients that define the diffractive lens structure are shown in TABLE 6.

TABLE 6
λ = 405 nm f = 1.25 mm NA 0.76

| Surface | | | | |
|---|---|---|---|---|
| Number | r | d | n (405 nm) | n (406 nm) |
| 1 | 0.752 | 1.23 | 1.50962 | 1.50947 |
| 2 | −0.756 | 0.25 | 1.62522 | 1.62486 |
| 3 | −1.270 | 0.35 | — | — |
| 4 | ∞ | 0.10 | 1.62231 | 1.62190 |
| 5 | ∞ | — | — | — |

TABLE 7

| Surface Number | 1 | 2 | 3 |
|---|---|---|---|
| κ | −0.5000 | −1.00000 | 0.0000 |
| A₄ | 1.9900 × 10⁻³ | 4.0200 × 10⁻¹ | 5.1630 × 10⁻¹ |
| A₆ | −2.3370 × 10⁻² | −2.9000 × 10⁻¹ | −6.1600 × 10⁻¹ |
| A₈ | −4.2430 × 10⁻² | 7.6000 × 10⁻² | 5.8750 × 10⁻¹ |
| A₁₀ | 9.7900 × 10⁻⁴ | 0.0000 | −2.8320 × 10⁻¹ |
| A₁₂ | −1.0800 × 10⁻¹ | 0.0000 | 6.4867 × 10⁻² |

TABLE 8

| Surface Number | 1 |
|---|---|
| P₂ | −3.2000 × 10 |
| P₄ | 0.0000 |
| P₆ | −1.0000 × 10 |
| P₈ | 0.0000 |
| P₁₀ | 0.0000 |

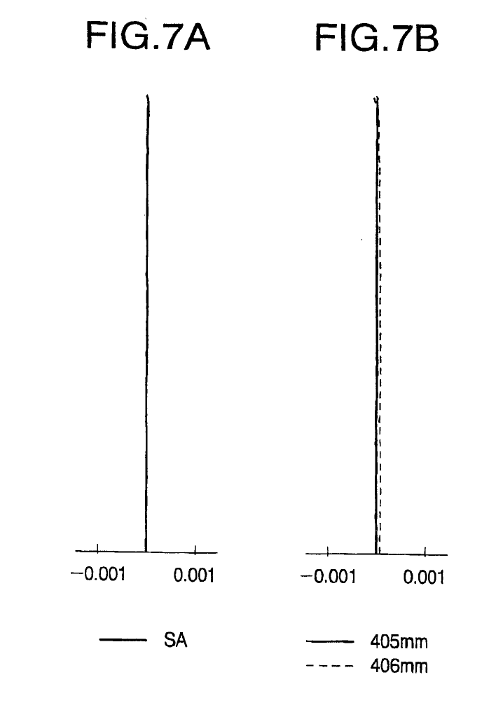

FIG. 7A is a graph showing spherical aberration of the cemented objective lens 20 according to the third concrete example at the working wavelength (405 nm) and FIG. 7B is a graph showing chromatic aberrations thereof represented by spherical aberrations at 405 nm and 406 nm.

FIG. 7A shows that the aspherical surfaces correct the spherical aberration well. FIG. 7B shows that the diffractive lens structure further corrects the chromatic aberration as compared with the first concrete example. Since the second lens 22 is also made of the ultraviolet-curing resin, the second lens 22 is thinner than that in the second concrete example while keeping the correction effect in chromatic aberration.

### Fourth Concrete Example

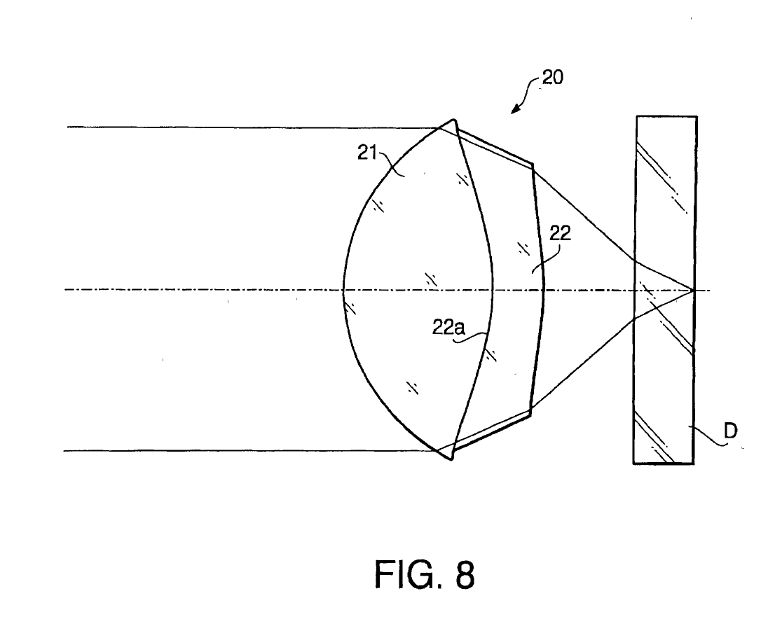

FIG. 8 is a lens diagram showing the cemented objective lens 20 of the fourth concrete example and the optical disc D. The first lens 21 of the objective lens 20 is made of ultraviolet-curing resin (photo-curing resin) and the second lens 22 is made of thermoplastic resin. The diffractive lens structure is not formed on any surface in the fourth concrete example.

The numerical configuration of the fourth concrete example is described in TABLE 9 and TABLE 10.

TABLE 9
λ = 660 nm f = 2.33 mm NA 0.64

| Surface | | | | |
|---|---|---|---|---|
| Number | r | d | n (660 nm) | n (661 nm) |
| 1 | 1.450 | 1.50 | 1.49856 | 1.49853 |
| 2 | −1.800 | 0.50 | 1.57961 | 1.57955 |
| 3 | −2.800 | 0.60 | — | — |
| 4 | ∞ | 0.60 | 1.57961 | 1.57955 |
| 5 | ∞ | — | — | — |

TABLE 10

| Surface Number | 1 | 2 | 3 |
|---|---|---|---|
| κ | −0.5000 | 0.00000 | 0.0000 |
| A₄ | −3.2480 × 10⁻³ | 8.2000 × 10⁻² | 7.3220 × 10⁻² |
| A₆ | 2.5250 × 10⁻⁴ | 0.0000 | 2.0150 × 10⁻² |
| A₈ | 1.4200 × 10⁻³ | 0.0000 | −1.3700 × 10⁻² |
| A₁₀ | 2.3060 × 10⁻⁴ | 0.0000 | 0.0000 |
| A₁₂ | 0.0000 | 0.0000 | 0.0000 |

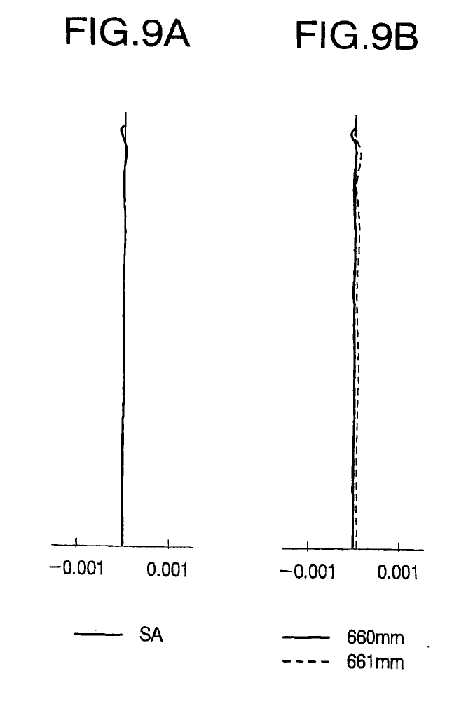

FIG. 9A is a graph showing spherical aberration of the cemented objective lens 20 according to the fourth concrete example at the working wavelength (660 nm) and FIG. 9B is a graph showing chromatic aberrations thereof represented by spherical aberrations at 660 nm and 661 nm.

FIG. 9A shows that the aspherical surfaces correct the spherical aberration well. FIG. 9B shows that the chromatic aberration is further corrected as compared with the first concrete example because the cemented objective lens of the fourth concrete example has smaller NA and longer design wavelength than the first concrete example.

The present disclosure relates to the subject matter contained in Japanese Patent Application No. 2001-370356, filed on Dec. 4, 2001, which is expressly incorporated herein by reference in its entirety.

What is claimed is:

1. A cemented objective lens consisting of a plurality of lenses, each of which is made of resin, at least one of said plurality of lenses being made of photo-curing resin.

2. A cemented objective lens consisting of a plurality of lens elements, each of which is made of resin, at least one of said plurality of lenses being made of thermo-curing resin.

3. A cemented objective lens comprising a first lens and a second lens, each of said first and second lens being made of resin, one of said first lens and said second lens being made of photo-curing resin.

4. The cemented objective lens according to claim 3, wherein said first lens has a positive power and said second lens has a negative power.

5. The cemented objective lens according to claim 4, wherein said first lens is made of the photo-curing resin.

6. The cemented objective lens according to claim 3, wherein cemented surfaces of said first lens and said second lenses are aspherical surfaces.

7. The cemented objective lens according to claim 3, wherein a diffractive lens structure is formed on at least one surface, which is not the cemented surfaces, of at least one of said first and second lenses.

8. The cemented objective lens according to claim 7, wherein said diffractive lens structure is formed on said first lens.

9. The cemented objective lens according to claim 1, wherein an NA of said cemented objective lens is greater than 0.6.

10. A cemented objective lens comprising a first lens and a second lens, said first and second lens being made of resin, one of said first lens and said second lens being made of thermo-curing resin.

11. The cemented objective lens according to claim 10, wherein said first lens has a positive power and said second lens has a negative power.

12. The cemented objective lens according to claim 11, wherein said first lens is made of the thermo-curing resin.

13. The cemented objective lens according to claim 10, wherein the cemented surfaces of said first and second lenses are aspherical surfaces.

14. The cemented objective lens according to claim 10, wherein a diffractive lens structure is formed on at least one surface, which is not the cemented surfaces, of at least one of said first and second lenses.

15. The cemented objective lens according to claim 14, wherein said diffractive lens structure is formed on said first lens.

16. The cemented objective lens according to claim 10, wherein an NA of said objective lens is greater than 0.6.

17. An optical system for an optical pick-up, comprising:
a laser source for emitting a laser beam; and
a cemented objective lens for converging the laser beam emitted from said laser source onto an information layer of an optical disc;
wherein said cemented objective lens consists of a plurality of lenses, each of which is made of resin, at least one of said plurality of resin being formed of photo-curing resin.

18. An optical system for an optical pick-up comprising:
a laser source for emitting a laser beam; and
a cemented objective lens for converging the laser beam emitted from said laser source onto an information layer of an optical disc;
wherein said cemented objective lens consists of a plurality of lenses, each of which is made of resin, at least one of said plurality of resin being formed of thermo-curing resin.

19. A method for manufacturing a cemented objective lens that comprises a first lens and a second lens cemented to each other comprising:
forming, the second lens made of resin;
setting the second lens in a molding die to form a cavity corresponding to the shape of the first lens;
charging photo-curing resin into the cavity; and
curing the photo-curing resin by applying light.

20. A method for manufacturing a cemented objective lens that comprises a first lens and a second lens cemented to each other comprising:
forming the second lens made of resin;
setting the second lens in a molding die to form a cavity corresponding to the shape of the first lens;
charging thermo-curing resin into the cavity; and
curing the thermo-curing resin by applying heat.
